(19) United States
(12) Patent Application Publication
(10) Pub. No.: US 2017/0013656 A1
(43) Pub. Date: Jan. 12, 2017

(54) EFFICIENT RESOURCE UTILIZATION

(71) Applicant: NOKIA SOLUTIONS AND NETWORKS OY, Espoo (FI)

(72) Inventors: Vinh VAN PHAN, Oulu (FI); Ling YU, Kauniainen (FI); Kari Veikko HORNEMAN, Oulu (FI)

(21) Appl. No.: 15/114,300

(22) PCT Filed: Jan. 28, 2014
(86) PCT No.: PCT/EP2014/051606

§ 371 Date: Jul. 26, 2016

(51) Int. Cl. H04W 76/02; H04W 4/08; H04W 8/00

(52) U.S. Cl. CPC H04W 76/023; H04W 8/005; H04W 4/08; H04W 92/20

(57) ABSTRACT

Apparatuses and methods for communication are provided. An example solution may include determining a need for requesting channel resources from other user terminals of a group of user terminals for proximity-based communications within the group of user terminals; transmitting a channel resource request to at least one user terminal of the group of user terminals; receiving one or more responses to the request, the one or more responses coming from other user terminals of the group and including information on available channel resources; selecting the channel resources to utilise and starting transmission utilising the selected channel resources.

### FIELD

The exemplary and non-limiting embodiments of the invention relate generally to wireless communication systems. Embodiments of the invention relate especially to apparatuses, methods, and computer program products in communication networks.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

In radio communication networks, such as the Long Term Evolution (LTE) or the LTE-Advanced (LTE-A) of the 3rd Generation Partnership Project (3GPP), network planning comprises the use of common base stations (Node B, eNodeB). User equipment (UE), or a user terminal (UT), may communicate with another UE or UT via the base station(s), for example. Alternatively, it is proposed that the UEs may communicate directly with each other by applying resources dedicated by the network for a device-to-device (D2D) direct communication or proximity services (ProSe). The D2D communication has proven to be network efficient by offloading the traffic processed in the base station(s), for example.

Examples of D2D communications include direct communications in a cluster of proximity devices; autonomous D2D communications in cellular network; grid or group of local machines communicating with each other while performing certain tasks in co-operative way; and advanced cellular device acting as a gateway for a number of low-capability devices or machines to access cellular network.

When planning communication systems the aim is to utilise available communication resources efficiently. In systems where D2D communication is possible this is a particularly challenging task as there may be several D2D groups utilising same resources in addition to normal cellular communication.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus, comprising: at least one processor; and at least one memory including computer program code, the at least one memory and the computer program code configured to, with the at least one processor, cause the apparatus at least to: determine a need for requesting channel resources from other user terminals of a group of user terminals for proximity-based communications within the group of user terminals; control the transmission of a channel resource request to at least one user terminal of the group of user terminals; control the reception of one or more responses to the request, the one or more responses coming from other user terminals of the group and comprising information on available channel resources; select the channel resources to utilise; control transmission utilising the selected channel resources.

According to an aspect of the present invention, there is provided an apparatus, comprising: at least one processor; and at least one memory including computer program code, the at least one memory and the computer program code configured to, with the at least one processor, cause the apparatus at least to: control the reception of a request from other user terminals of a group of user terminals for proximity-based communications within the group of user terminals, the request indicating that a user terminal of the group is in need for channel resources; determine if the apparatus has resources available for sharing and if so, control the transmission of a response to the request, the response comprising information on available channel resources.

According to an aspect of the present invention, there is provided an apparatus, comprising: at least one processor; and at least one memory including computer program code, the at least one memory and the computer program code configured to, with the at least one processor, cause the apparatus at least to: control the reception of a request from a user terminal of a group of user terminals, the request indicating that the user terminal is in need for channel resources for proximity-based communications within the group of user terminals; determine if the apparatus has resources available for sharing and, if not, control the transmission of a channel resource request to at least one other user terminal of the group of user terminals.

According to an aspect of the present invention, there is provided a method comprising: determining a need for requesting channel resources from other user terminals of a group of user terminals for proximity-based communications within the group of user terminals; controlling the transmission of a channel resource request to at least one user terminal of the group of user terminals; controlling the reception of one or more responses to the request, the one or more responses coming from other user terminals of the group and comprising information on available channel resources; selecting the channel resources to utilise; controlling transmission utilising the selected channel resources.

According to an aspect of the present invention, there is provided a method comprising: controlling the reception of a request from other user terminals of a group of user terminals for proximity-based communications within the group of user terminals, the request indicating that a user terminal of the group is in need for channel resources; determining if there are resources available for sharing and if so, controlling the transmission of a response to the request, the response comprising information on available channel resources.

According to an aspect of the present invention, there is provided a method comprising: controlling the reception of a request from a user terminal of a group of user terminals, the request indicating that the user terminal is in need for channel resources for proximity-based communications within the group of user terminals; determining if the apparatus has resources available for sharing and, if not, controlling the transmission of a channel resource request to at least one other user terminal of the group of user terminals.

According to an aspect of the present invention, there is provided a computer program embodied on a distribution medium, comprising program instructions which, when loaded into an electronic apparatus, are configured to control the apparatus to execute: determining a need for requesting channel resources from other user terminals of a group of user terminals for proximity-based communications within the group of user terminals; controlling the transmission of a channel resource request to at least one user terminal of the group of user terminals; controlling the reception of one or more responses to the request, the one or more responses coming from other user terminals of the group and comprising information on available channel resources; selecting the channel resources to utilise; controlling transmission utilising the selected channel resources.

According to an aspect of the present invention, there is provided a computer program embodied on a distribution medium, comprising program instructions which, when loaded into an electronic apparatus, are configured to control the apparatus to execute: controlling the reception of a request from other user terminals of a group of user terminals for proximity-based communications within the group of user terminals, the request indicating that a user terminal of the group is in need for channel resources; determining if there are resources available for sharing and if so, controlling the transmission of a response to the request, the response comprising information on available channel resources.

According to an aspect of the present invention, there is provided a computer program embodied on a distribution medium, comprising program instructions which, when loaded into an electronic apparatus, are configured to control the apparatus to execute:

controlling the reception of a request from a user terminal of a group of user terminals, the request indicating that the user terminal is in need for channel resources for proximity-based communications within the group of user terminals; determining if the apparatus has resources available for sharing and, if not, controlling the transmission of a channel resource request to at least one other user terminal of the group of user terminals.

### LIST OF DRAWINGS

Embodiments of the present invention are described below, by way of example only, with reference to the accompanying drawings, in which

FIG. 1 illustrates an example of a communication environment;

FIGS. 2, 3, 4, 5 and 6 are flowcharts illustrating some embodiments of the invention;

FIG. 7 illustrates an example of an embodiment with a signalling chart; and

FIG. 8 illustrates an example of an apparatus applying embodiments of the invention.

### DESCRIPTION SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features, structures, units, modules etc. that have not been specifically mentioned.

Embodiments are applicable to any base station, node, server, host, user terminal (UT), user equipment (UT), user device, corresponding component, and/or to any communication system or any combination of different communication systems that support required functionalities.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

Many different radio protocols to be used in communications systems exist. Some examples of different communication systems are the universal mobile telecommunications system (UMTS) radio access network (UTRAN or E-UTRAN), long term evolution (LTE®, known also as E-UTRA), long term evolution advanced (LTE-A®), Wireless Local Area Network (WLAN) based on IEEE 802.11 standard, worldwide interoperability for microwave access (WiMAX), Bluetooth®, personal communications services (PCS) and systems using ultra-wideband (UWB) technology. IEEE refers to the Institute of Electrical and Electronics Engineers. LTE and LTE-A are developed by the Third Generation Partnership Project 3GPP.

In the following, different exemplifying embodiments will be described using, as an example of an access architecture to which the embodiments may be applied, a radio access architecture based on long term evolution advanced (LTE Advanced, LTE-A), that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately.

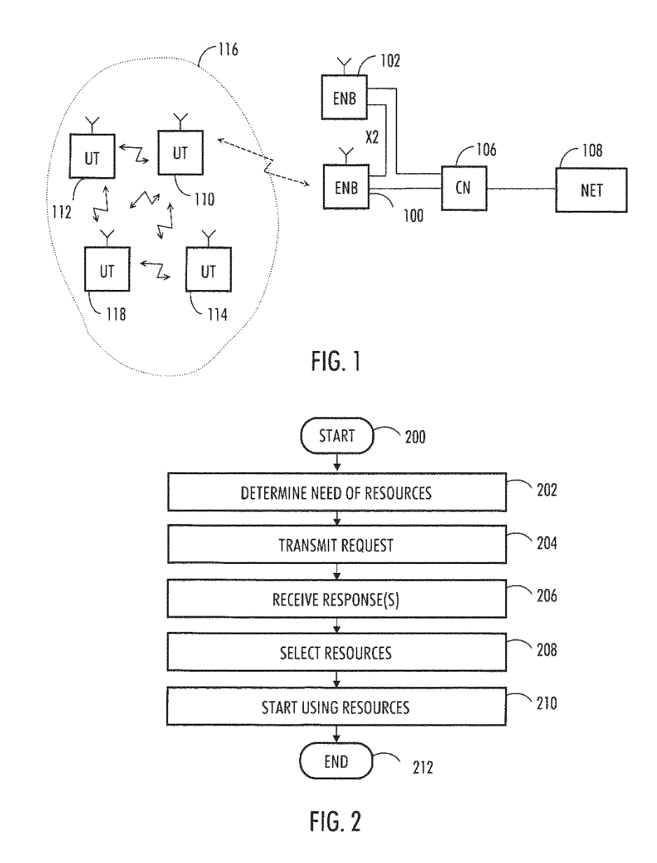

FIG. 1 illustrates a simplified view of a communication environment only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for communication are irrelevant to the actual invention. Therefore, they need not to be discussed in more detail here.

In the example of FIG. 1, a radio system based on long term evolution advanced (LTE Advanced, LTE-A) network elements is shown. However, the embodiments described in these examples are not limited to the LTE-A radio systems but can also be implemented in other radio systems.

FIG. 1 shows eNodeBs 100 and 102 connected to core network (CN) 106 of a communication system. The eNodeBs are connected to each other over an X2 interface.

The eNodeBs 100, 102 that may also be called base stations of the radio system may host the functions for Radio Resource Management: Radio Bearer Control, Radio Admission Control, Connection Mobility Control, Dynamic Resource Allocation (scheduling). Depending on the system, the counterpart on the CN side can be a serving gateway (S-GW, routing and forwarding user data packets), packet data network gateway (P-GW, for providing connectivity of user devices (UEs) to external packet data networks), and/or mobile management entity (MME), etc. The MME (not shown) is responsible for the overall user terminal control in mobility, session/call and state management with assistance of the eNodeBs through which the user terminals may connect to the network.

The communication system is also able to communicate with other networks, such as a public switched telephone network or the Internet 108. The communication network may also be able to support the usage of cloud services. It should be appreciated that eNodeBs or their functionalities may be implemented by using any node, host, server or access point etc. entity suitable for such a usage.

The user terminal UT (also called user device, user equipment, terminal device, etc.) illustrates one type of an apparatus to which resources on the air interface may be allocated and assigned, and thus any feature described herein with a user device may be implemented with a corresponding apparatus, such as a relay node. An example of such a relay node is a layer 3 relay (self-backhauling relay) towards the base station.

The user terminal typically refers to a portable computing device that includes wireless mobile communication devices operating with or without a subscriber identification module (SIM), including, but not limited to, the following types of devices: a mobile station (mobile phone), smartphone, personal digital assistant (PDA), device using a wireless modem (alarm or measurement device, etc.), laptop and/or touch screen computer, tablet, game console, notebook, and multimedia device.

The user terminal (or in some embodiments a layer 3 relay node) is configured to perform one or more of user equipment functionalities. The device may also be called a subscriber unit, mobile station, remote terminal, access terminal, user equipment (UE) just to mention but a few names or apparatuses.

Further, although the apparatuses have been depicted as single entities, different units, processors and/or memory units (not all shown in FIG. 1) may be implemented.

FIG. 1 shows four user terminals 110, 112, 114 and 118 which are participating in a direct device-to-device communication. The user terminals (UTs) form a device-to-device communication group or cluster 116. There may be several D2D groups or cluster in the same area.

Device-to-device communications can be considered as a form of peer-to-peer networking. There is a wide variety of such systems. Examples of such systems include mobile communications systems, Internet of Things (IoT) systems, wireless sensor network systems, proximity-based service systems, public warning systems, public safety

(PS) systems supporting direct device-to-device communications and cyber-physical systems (CPS). Internet of Things connects different sources of information such as sensors, mobile phones and cars that consume and process information in different environments such as logistic applications, factories and airports as well as in the work and everyday lives of people. A cyber-physical system is a system of collaborating computational elements controlling physical entities. Examples of cyber-physical systems include mobile robotics and electronics transported by humans or animals.

In an embodiment it is proposed to utilise a star-topology in a D2D cluster. In such a solution a selected terminal is taking a special role, referred to as the cluster head (CH), in coordinating and perhaps controlling possible D2D communications among cluster members. In an embodiment, a D2D cluster may utilise broadcast based D2D communications between the UTs of the group. The cluster head may coordinate and allocate channel resources for cluster members to transmit for their requested individual user(s) or user group(s) within the cluster. The cluster head CH may coordinate and control resource usage to ensure efficient and fair resource sharing among individual active users and user groups being members of the cluster, taking into account diverse traffic demands and other group/user and service profile characteristics, such as priorities.

In the example of FIG. 1, UT 110 is the cluster head. The cluster head may have a connection with eNodeB 100. However, the D2D may as well operate on areas where the communication system is not available.

In an embodiment, the CH is configured (by itself in autonomous operation or by serving network in network-controlled operation) to form a set of pre-defined radio channel resources which can be used for D2D communication within the cluster. Furthermore, the CH may have a pre-allocated broadcast control channel which can be the same or different from the beaconing channel and used to send control information to cluster members. In the latter case, information about the broadcast or groupcast control channel of CH is indicated in the beaconing channel so that members can find and listen to that channel. The broadcast control channel of CH may also have a primary-secondary structure for enhancing flexibility and capacity of the broadcast control signalling. For broadcast service, any device which is able to listen to the service may be considered as a member of the cluster. Those members which only listen at a certain time are referred to as passive members. Those who also transmit are referred to as active members. Every UT can be passive member at one time, but be active member in another time due to the half-duplex operation assumption.

The UT members of a D2D group controlled by a CH may transmit resource allocation messages to the CH when they are in need of resources. If resources are available the CH may allocate resources for the UTs.

In an embodiment, a present active user group under control of a CH is assigned a maximum fair share of N channel resources and each active member of the user group may occupy and transmit on at least one of those assigned channels. This means that there can be utmost N active members in the user group in parallel. In the group communication based on 1:M (one to many/multipoint) D2D communication, an active member is supposed to transmit for the rest of the user group. Based on the latest updated broadcast control information of CH, group members are aware of all the N allocated channels of the user group.

In an embodiment, it is proposed a hybrid centralized/distributed broadcast control scheme which allows for a member of a D2D group to request and use allocated channel(s) of other active members temporarily on the need basis. For one instance, an active member of a group which are conducting a D2D based push-to-talk group call may be in need of broadcasting some live videos for the group and find that the current channel allocated to it is not sufficient enough for that need. In this example, one option is that the active UT in need may request the cluster head CH for some new channel resources and the CH, depending on the available resources and fairness in resource sharing among active cluster members and user groups thereof, may decide whether to allocate more channel resources for the active UT in need and, therefore, the user group thereof. This option is rather straightforward and not in focus here. In an embodiment, an option is considered in which the CH cannot assign any more resources for the UT in need and the user group thereof due to the constrains of available resources within the cluster and/or fairness of resource sharing among the user groups within the cluster. This includes also the case in which a passive UT member is in need of becoming active and transmitting for the user group but the CH is not able to allocate any more channel resources to that passive UT and the user group thereof. The UT in need, whether active or passive, may then try to pool (pull) resources from other active UTs within the user group for its need, with/without assistance from the CH.

FIG. 2 is a flowchart illustrating an embodiment of the invention. The embodiment starts at step 200. The example of FIG. 2 illustrates an example of the operation of user terminal which is in a direct device-to-device communication or proximity-based communication with a group of user terminals and is in need of resources.

In step 202, the user terminal is configured to determine a need for requesting channel resources from other user terminals of a group of user terminals for proximity-based communications within the group of user terminals.

In step 204, the user terminal is configured to transmit a channel resource request to at least one user terminal of the group of user terminals.

In step 206, the user terminal is configured to receive one or more responses to the request, the one or more responses coming from other user terminals of the group and comprising information on available channel resources.

In step 208, the user terminal is configured to select the channel resources to utilise.

In step 210, the user terminal is configured to start transmission utilising the selected channel resources.

The process ends in step 212.

In an embodiment, a control scheme is proposed for facilitating user group based channel pooling for efficient resource utilization in L1 broadcast based proximity-based (1:M D2D) communications in which a user terminal being a member of the group is allowed to request and use allocated channel resources of other active members, typically temporarily, on the need basis. In an embodiment, the proposed scheme may comprise of at least messages: Channel Pooling Request (for requesting channel resources); Channel Pooling Response (as a response to channel resource request); Channel Pooling Release (for releasing used resources, optional); and Channel Reclaim Request (for avoiding resource collision, optional) which may be exchanged between the involved parties including a user terminal, user device, user equipment, UT in need of resources, cluster head CH, and other members of the user group wherein the user terminal in need belongs to.

Let us first study examples of the operation of a UT which is a member of a user group conducting, or about to conduct, D2D group communication under control of a CH and which UT is currently in need of new channel resources. The UT may be referred to the UT in need for short.

In an embodiment, the UT in need is configured to determine whether to send a resource allocation (RA) request to CH or not. The decision may depend on at least one of the following: whether the UT it is an active member, having some channel resources allocated to it, or a passive member, having no channel resources allocated to it and on prior knowledge whether the CH is able to assign anymore channel resources for the present user group thereof or not. The details are as follows:

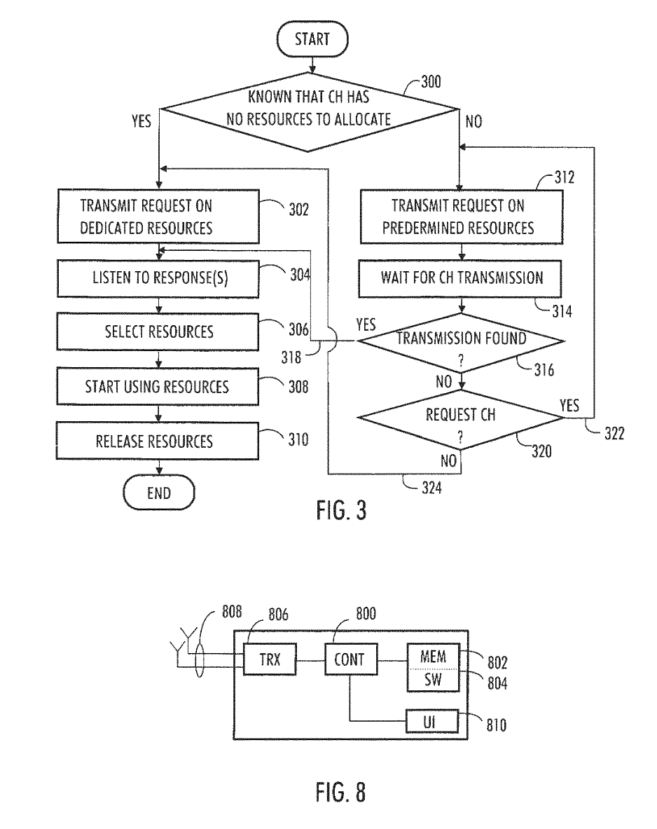

Let us first study an example where the UT in need of channel resources is an active member in the group. Thus, it already has some channel resources allocated to it. The example is illustrated by the flowchart of FIG. 3

If the UT in need knows beforehand in step 300 that the CH is not able to assign anymore channel resources to its user group—as the CH may advertise about that in advance in conjunction with other allocation messages, the UT in need may determine not to send a RA request to the CH.

As an active member, the UE in need may broadcast or groupcast in step 302 a message (which may be denoted as a Channel Pooling Request) on a channel resource allocated to it to its user group, targeted for other active members of the user group which are having some channel resources allocated to them individually. The Channel Pooling Request may include identity (ID) of the UT in need, targeted Group identity (ID), ‘cause’ of the request(e.g. type of the needed communications (speech, data)), and further information specifying the request.

The UT in need then listens in step 304 to active members of its user group not only for receiving group communication data but also for expected response messages.

The UT in need may hear some response message(s) (which may be denoted as Channel Pooling Response(s)) from other active members of the targeted user group sent in individual channel resources allocated to them for transmission (and the user group to receive). The Channel Pooling Response may include a temporary permission allowing for the requesting UT (as indicated by UT ID of the UT in need in the response message) to use the corresponding channel (in which the Channel Pooling Response is received) typically for a certain specified period of time, e.g., starting from the instance the Channel

Pooling Response is sent or given with a specified ending time of the permit. The Channel Pooling Response may further comprise identity (ID) of the permit issuing active member or Group identity.

The UT in need may select in step 306 from the received responses the resources to utilise. In an embodiment, the responses may also indicate whether the permission to use indicated resources is a commitment for the specified period of time indicated or whether the issuing active member may reclaim it later. This indication may be useful for the requesting UT in need to select most preferable resources for use (e.g., take into consideration possible collision due to that some permit-issuing active member may reclaim and use the corresponding channel resources without any further notice).

If no response is received from any other active member for a certain preconfigured time interval (implemented for example by a timer starting from the instance of issuing of Channel Pooling Request), the UT in need may try again, provided that the need for resources is still valid.

In step 308 the UT in need starts transmitting on a channel of the channel pool, as temporarily permitted and selected. In an embodiment, the first transmission of the UT on the first scheduled occasion of the selected channel resources permitted by the corresponding other active member(s) may also act as an acknowledgement that the corresponding permission(s) are regarded as granted and used. In an embodiment, for those permissions which are not needed or not selected by the UT in need, the UT in need may send an explicit Channel Pooling Release on the first scheduled occasion of those corresponding channel resources, as the corresponding other active member(s) may monitor their channel resources and reclaim it if they detect that the UT in need does not use it.

In an embodiment, the number of first scheduled occasions for the aforementioned monitoring and detection may be made configurable as relying on monitoring only the first scheduled occasion of the permitted channel resources is not robust or reassuring enough, especially when considering Layer 1/Layer 2 broadcast based transmission without Layer 1/Layer 2 acknowledgement feedback.

In an embodiment, the UT in need may issue a message (which may be denoted as Channel Pooling Release) in step 310 indicating the release of resources on any individual channel resources of the channel pool currently allocated to it if the UT in need no longer has a need for the temporarily permitted channel resources. If the Channel Pooling Release does not specify which (or all) of the temporarily permitted channel resources to be released (i.e., to be returned to the corresponding active member before the granted period expires) the channel resources in which the Channel Pooling Release are sent is considered as the channel resources to be released.

In an embodiment, the UT in need may listen to other active members of the group for indication of possible collision happening on one or more of the temporarily permitted channel resources. An example of such a collision is an implicit Channel Reclaim Request (a permission-issuing active member may reclaim and use the corresponding channel resources without any further notice to the UT) or explicit an Channel Reclaim Request (some permission-issuing active member may have more than one channels allocated to it and permit the UT in need to use only part of those). The UT in need may refrain from those channel resources on which the collision happened as indicated or which are listed in the Channel Reclaim Request as requested, considering that the corresponding active member(s) want to reclaim those channel resources earlier than the granted period of time indicated in the corresponding permission.

It may be noted that due to the use of broadcast or groupcast based control in the above group communication, any members of the group may be able to monitor about the resource pooling of the UT in need and therefore have a certain awareness of the process and outcome of the channel pooling, i.e., what is expected to come. Those active members of the group which are actually taking part in the channel pooling (by responding) may use that awareness to determine, for example, on their individual permission to be issued and condition or need of reclaiming resources early.

In addition or alternatively, the UT in need may listen to CH for Channel Reclaim Request of corresponding channel resources (of an active member).

If the UT in need does not know beforehand in step 300 that the cluster head CH is not able to assign more channel resources to its user group, the UT in need may determine to send in step 312 a resource allocation (RA) request to the cluster head CH. The RA request may include UT ID of the UT in need, targeted Group ID, ‘cause’ of the request, and further information specifying the request. The request may be carried out by sending a Channel Pooling Request to CH on a pre-configured channel allocated by CH for such signalling purposes.

The UT in need then waits in step 314 for CH transmission. It should be noted that herein the focus is on the system operation provided that CH cannot assign any more new channel resources for the UT in need and group thereof. (That CH otherwise assigns new channel resources for the UT and the UT start using the new channel resources is considered as a straightforward operation.)

The UT in need in step 316 may hear that CH broadcasts or groupcasts a Channel Pooling Request for it to the indicated user group, in response to its request. In such a case 318, the UT is configured to listen for responses and the process continues in step 304.

If not, the UT may in step 320 determine that a new attempt to send the request to CH is more favourable and it may reattempt 322 sending the request to CH with some back-off time interval.

On the other hand 324, the UT in need may broadcast a Channel Pooling Request on the channel resource allocated to it to its user group, targeted for other active members of the user group which are having some channel resources allocated to them individually. Thus, the process continues in step 302. It may be noted that the active UT in need may also broadcast a Channel Pooling Request on the channel resource allocated to it to its user group upon hearing that CH broadcasts a Channel Pooling Request for it in response to its RA request.

Above it has been assumed that the UT is an active member having some resources allocated to it.

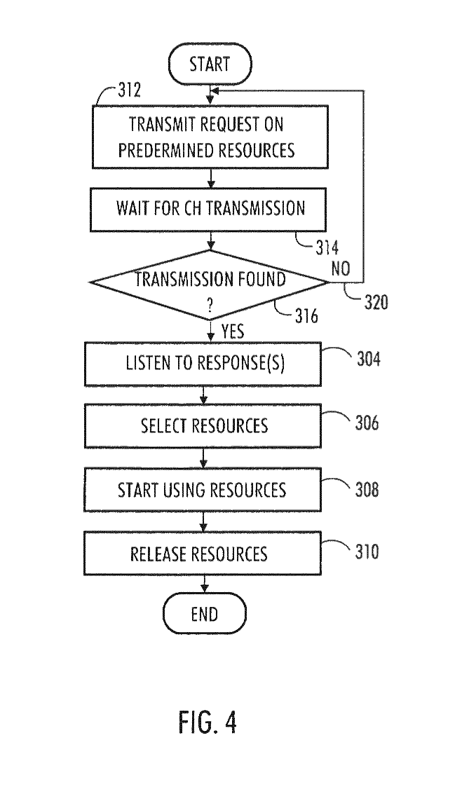

Let us study an example wherein the UT in need of channel resources is a passive member in the group. FIG. 4 is a flowchart illustrating this example. The steps are numbered with same reference number as in FIG. 3. A passive member the UT has no resources allocated to it. In this case, having determined that resources are needed and that CH is not able to assign anymore resources to the user group of the UT, the UT in need may send in step 312 a Channel Pooling Request to CH on a pre-configured channel allocated by CH for such signalling purposes. If the UE in need does not know that CH is not able to assign anymore resources to the user group of the UT, the UE in need may send in step 312 a RA request to CH, as in 312 of FIG. 3.

The UT in need then waits in step 314 to CH for expectable outcomes.

The UT in need in step 316 may hear that CH broadcasts or groupcasts a Channel Pooling Request for it to the indicated user group, in response to its request, as targeted. In such a case, the UT is configured to listen for responses and the process continues in step 304 as described above in connection with FIG. 3.

If not, the UT may reattempt sending the request to CH in step 312 with a back-off time interval which may be predetermined or randomly chosen.

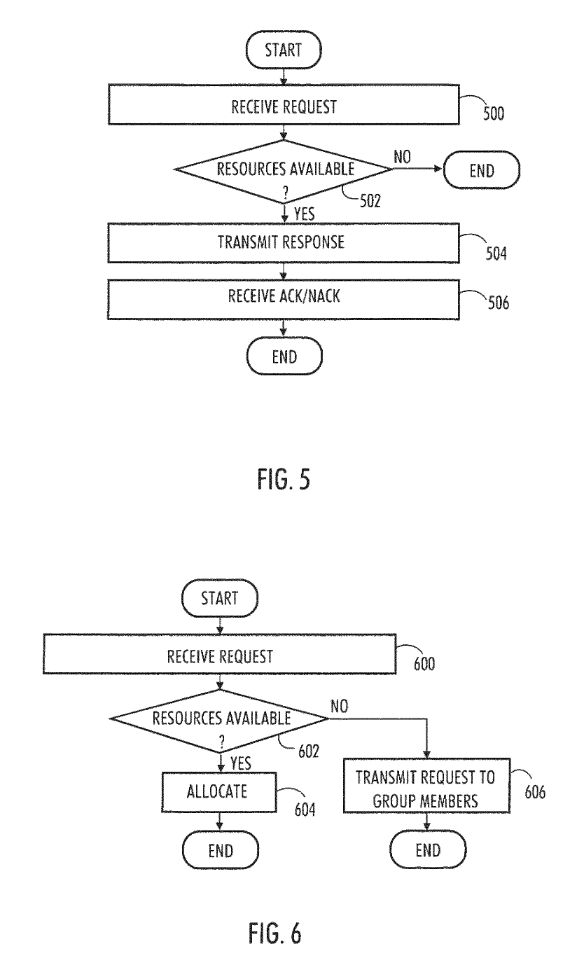

Let us next study an example of the operation of user terminal which is a member in a D2D group and receives a request for resources. The flowchart of FIG. 5 illustrates this example.

In step 500, the user terminal is configured to receive a request from other user terminals of a group of user terminals for proximity-based communications within the group of user terminals, the request indicating that a user terminal of the group is in need for channel resources.

In step 502, the user terminal is configured to determine if the apparatus has resources available for sharing. If not, the process ends.

If resources are available the user terminal transmits in step 504 a response to the request, the response comprising information on available channel resources.

In an embodiment, the user terminal may be configured to transmit the response on dedicated channel resources allocated to it. In case the information on available channel resources is omitted from the response the dedicated channel resources on which the response is sent are assumed.

The user terminal may be configured to include in the response a time interval the resources are available. The user terminal may further be configured to include in the response an indication whether the user terminal may request the resources back within the indicated time interval.

In an embodiment, the user terminal may be configured to receive the request on dedicated channel resources allocated to the user terminal requesting resources. The user terminal may also be configured to receive the request from CH on predetermined resources allocated for signalling purposes.

In an embodiment, the user terminal may be configured to receive acknowledgement in step 506 from the UT in need. The acknowledgement may be detected when the UT in need starts using the offered resources. The acknowledgement may be detected as the UT in need may issue an explicit Channel Pooling Release of those offered resources which the UT in need did not select. In one option, a Channel Pooling Release is sent using the offered resources, in which case the UT in need did not select the offered resources for use.

In an embodiment, the user terminal may require the offered resources before an optional time interval expired. In such a case the user terminal may be further configured to transmit a request indicating that the user terminal needs the resources back before the expiration of the indicated time interval. The request may be denoted a Channel Reclaim Request. The request may be sent via the cluster head or on the remaining dedicated channel resources of the UT. The request may comprise the UT ID of the UT in need and the UT ID of the requesting member and the Group ID.

Let us next study an example of the operation of user terminal which acts as a cluster head of a D2D group. The flowchart of FIG. 6 illustrates this example.

In step 600, the user terminal controls the reception of request from a user terminal of a group of user terminals, the request indicating that the user terminal is in need for channel resources for proximity-based communications within the group of user terminals.

In step 602, the user terminal determines if the apparatus has resources available for sharing.

If resources are available, they may be allocated to the requesting user terminal in step 604 and the process ends.

If resources are not available, the user terminal is configured in step 606 to transmit the channel resource request at least one other user terminal of to the group of user terminals and the process ends.

The user terminal acting as the cluster head may further be configured to receive a request (a Channel Reclaim Request) from a first user terminal having given some channel resources to another user terminal, the request indicating that the first user terminal itself needs the resources. In such a case the user terminal acting as the cluster head may be configured to transmit the request to the group of user terminals, the request comprising the identifications of the first user terminal and the other user terminal.

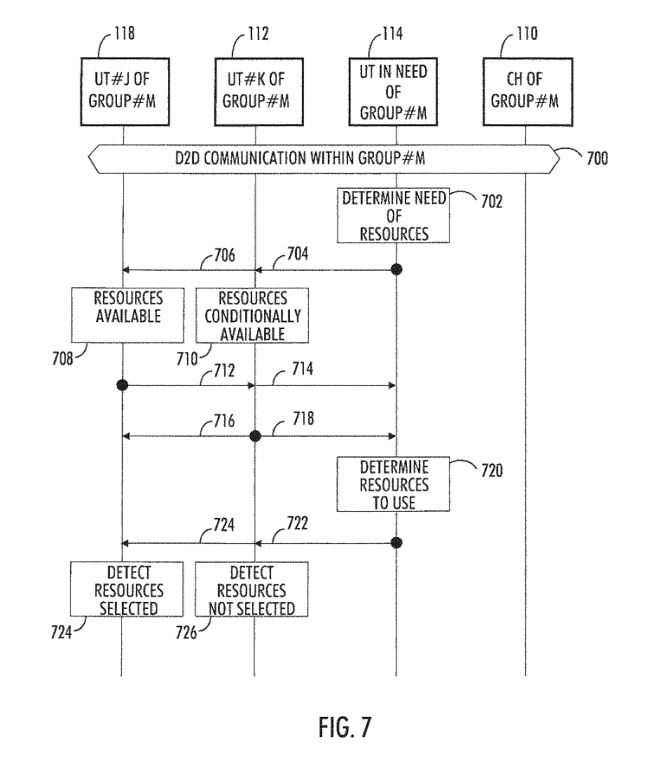

FIG. 7 is a signalling chart illustrating an embodiment. It illustrates an example where an active member of a group of user terminals participating D2D communication needs resources and the channel pooling happens without the need of assistance from the cluster head of the group.

In the example of FIG. 7, three user terminals, UT#J 118, UT#K 112 and UT in need 114 are involved. The user terminals and the cluster head 110 are involved in D2D communication 700 within a Group#M as active members.

In step 702, the UT in need 114 determines that it has a need of more resources, for example for broadcasting some live videos for the Group#M.

The UT in need broadcasts 704, 706 a Resource Pooling Request to other members of the group.

The UT#J 118 receives the broadcast and determines in step 708 that it has available resources that it can give to the UE in need without conditions. The UT#J broadcasts 712, 714 a Resource Pooling Response. The UT#K 112 receives the broadcast and determines in step 710 that it has available resources that it can give to the UE in need with the condition that it may reclaim the resources back at any point of time. The UT#K broadcasts 716, 718 a Resource Pooling Response.

In step 720, the UT in need determines to utilise the resources offered by the UT#J and disregard the resources offered by the UT#K.

The UT in need starts data transmission 722, 724 utilising the resources offered by the UT#J.

In step 724, the UT#J detects the transmission of the UT in need and determines that the resources it offered are used and refrains from using the same resources. In step 726, the UT#K detects the transmission of the UT in need and determines that the resources it offered are not used. Therefore it reclaims the resources right away.

Above embodiments of the invention have been described assuming autonomous D2D communications. However, embodiments of the invention are not limited to such scenario it may be realized also in network-controlled D2D communications. In such cases many elements may be realized using possible assistance services from the network (the serving eNB). Referring to FIG. 1, the serving eNB 100 may be considered as a coordination point or master of all CHs operating inside the cell served by the eNodeB. In this regard, the serving eNB may be able to take over or provide assistance in any functions of CH towards members using cellular access.

FIG. 8 illustrates an embodiment. The figure illustrates a simplified example of an apparatus in which embodiments of the invention may be applied. In some embodiments, the apparatus may be user equipment, user device or user terminal or a part of it capable of joining and communicating in a device-to-device cluster (and communicating with an eNodeB).

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus of the example includes a control circuitry 800 configured to control at least part of the operation of the apparatus. The control circuitry 800 is configured to execute one or more applications.

The apparatus may comprise a memory 802 for storing data or applications. Furthermore the memory may store software 804 executable by the control circuitry 800. The memory may be integrated in the control circuitry.

The apparatus comprises at least one transceiver 806. The transceiver is operationally connected to the control circuitry 800. It may be connected to an antenna arrangement 808 comprising one or more antenna elements or antennas.

The software 804 may comprise a computer program comprising program code means adapted to cause the control circuitry 800 of the apparatus to control a transceiver 806.

The apparatus may further comprise user interface 810 operationally connected to the control circuitry 800. The interface may comprise a (touch sensitive) display, a keypad, a microphone, and a speaker, for example.

If the apparatus is the UT in need, the applications may cause the apparatus at least to determine a need for requesting channel resources from other user terminals of a group of user terminals for proximity-based communications within the group of user terminals; control the transmission of a channel resource request to at least one user terminal of the group of user terminals; control the reception of one or more responses to the request, the one or more responses coming from other user terminals of the group and comprising information on available channel resources; select the channel resources to utilise; control transmission utilising the selected channel resources.

If the apparatus is the another UT of a D2D group, the applications may cause the apparatus at least to control the reception of a request from other user terminals of a group of user terminals for proximity-based communications within the group of user terminals, the request indicating that a user terminal of the group is in need for channel resources; determine if the apparatus has resources available for sharing and if so, control the transmission of a response to the request, the response comprising information on available channel resources.

If the apparatus is a cluster head of a D2D group, the applications may cause the apparatus at least to control the reception of a request from a user terminal of a group of user terminals, the request indicating that the user terminal is in need for channel resources for proximity-based communications within the group of user terminals; determine if the apparatus has resources available for sharing and, if not, control the transmission of a channel resource request to at least one other user terminal of the group of user terminals.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described embodiments may be implemented as an electronic digital computer, or a circuitry which may comprise a working memory (RAM), a central processing unit (CPU), and a system clock. The CPU may comprise a set of registers, an arithmetic logic unit, and a controller. The controller or the circuitry is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) one or more portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. The medium may be a non-transitory medium. Depending on the processing power needed, the computer program may be executed in a single electronic digital computer or it may be distributed amongst a number of computers.

An embodiment provides an apparatus, comprising: means (800) for determining a need for requesting channel resources from other user terminals of a group of user terminals for proximity-based communications within the group of user terminals; means (800) for controlling the transmission of a channel resource request to at least one user terminal of the group of user terminals; means (800) for controlling the reception of one or more responses to the request, the one or more responses coming from other user terminals of the group and comprising information on available channel resources; means (800) for selecting the channel resources to utilise and means for controlling transmission utilising the selected channel resources.

Another embodiment provides an apparatus, comprising: means (800) for controlling the reception of a request from other user terminals of a group of user terminals for proximity-based communications within the group of user terminals, the request indicating that a user terminal of the group is in need for channel resources; means (800) for determining if there are resources available for sharing and if so, controlling the transmission of a response to the request, the response comprising information on available channel resources.

Yet another embodiment provides an apparatus, comprising: means (800) for controlling the reception of a request from a user terminal of a group of user terminals, the request indicating that the user terminal is in need for channel resources for proximity-based communications within the group of user terminals; means (800) for determining if the apparatus has resources available for sharing and, if not, controlling the transmission of a channel resource request to at least one other user terminal of the group of user terminals.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as the technology advances, the inventive concept can be implemented in various ways. The invention and its embodiments are not limited to the examples described above but may vary within the scope of the claims.

1. An apparatus, comprising:
at least one processor; and
at least one memory including computer program code, the at least one memory and the computer program code configured to, with the at least one processor, cause the apparatus at least to:
determine a need for requesting channel resources from other user terminals of a group of user terminals for proximity-based communications within the group of user terminals;
control a transmission of a channel resource request to at least one user terminal of the group of user terminals;
control a reception of one or more responses to the request, the one or more responses coming from other user terminals of the group and including information on available channel resources;
select channel resources to utilise;
control a transmission that utilises the selected channel resources.

2. The apparatus of claim 1, further configured to:
utilise given dedicated channel resources to maintain a direct device-to-device communication with one or more user terminals; and
control the transmission of the channel resource request on the given dedicated channel resources.

3. The apparatus of claim 1, further configured to:
determine, prior to controlling the transmission of a channel resource request to at least one user terminal of the group of user terminals, that a cluster head controlling the device-to-device communication of the group cannot provide channel resources.

4. The apparatus of claim 1, wherein the channel resource request includes at least one of the following:
an identification (UT ID) of the apparatus, an identification (Group ID) of the group of user terminals, and a cause for the channel resource request.

5. The apparatus of claim 1, further configured to control the reception of one or more responses to the request, the one or more responses comprising a time period the channel resources are available for use.

6. The apparatus of claim 1 further configured to transmit the channel resource request to a user terminal controlling the device-to-device communication within the group.

7. The apparatus of claim 1, further configured to inform the at least one user terminal of the group of user terminals about the channel resources selected to utilise.

8. The apparatus of claim 1, further configured to inform the at least one user terminal of the group of user terminals about the channel resources indicated available but not selected to utilise.

9. The apparatus of claim 8, further configured to transmit on a channel resource indicated as available but not selected, a message indicating that the channel resource was not selected.

10. The apparatus of claim 1, wherein the selection of the channel resources to utilise comprises: obtaining information on resources the utilisation of which causes a risk of collision and not selecting those resources.

11. An apparatus, comprising:
at least one processor; and
at least one memory including computer program code,
the at least one memory and the computer program code configured to, with the at least one processor, cause the apparatus at least to:
control a reception of a request from other user terminals of a group of user terminals for proximity-based communications within the group of user terminals, the request indicating that a user terminal of the group is in need for channel resources;
determine if the apparatus has resources available for sharing and if so, control the a transmission of a response to the request, the response comprising information on available channel resources.

12. The apparatus of claim 11, further configured to include in the response a time interval the resources are available.

13. The apparatus of claim 12, further configured to include in the response an indication whether the apparatus may request the resources back within the indicated time interval.

14. The apparatus of claim 11, further configured to control the reception of the request on dedicated channel resources allocated to the user terminal requesting resources.

15. The apparatus of claim 11, further configured to control the reception of the request on predetermined resources allocated for signalling purposes.

16. The apparatus of claim 11, further configured to control a transmission of a request indicating that the apparatus needs the resources back before the expiration of the indicated time interval.

17. An apparatus, comprising:
at least one processor; and
at least one memory including computer program code,
the at least one memory and the computer program code configured to, with the at least one processor, cause the apparatus at least to:
control a reception of a request from a user terminal of a group of user terminals, the request indicating that the user terminal is in need for channel resources for proximity-based communications within the group of user terminals;
determine if the apparatus has resources available for sharing and, if not,
control a transmission of a channel resource request to at least one other user terminal of the group of user terminals.

18. The apparatus of claim 17, further configured to:
control a reception of a request from a first user terminal that shared some channel resources to a second user terminal, the request indicating that the first user terminal needs the resources back; and
control the transmission of the request, which indicates that the first user terminal needs the resources back, to the group of user terminals, the request including an identification of the first user terminal and the other user terminal.

19. A method, comprising:
determining a need for requesting channel resources from other user terminals of a group of user terminals for proximity-based communications within the group of user terminals;
controlling a transmission of a channel resource request to at least one user terminal of the group of user terminals;
controlling a reception of one or more responses to the request, the one or more responses coming from other user terminals of the group and including information on available channel resources;
selecting a channel resources to utilise;
controlling a transmission that utilises the selected channel resources.

20-28. (canceled)

29. A method, comprising:
controlling a reception of a request from other user terminals of a group of user terminals for proximity-based communications within the group of user terminals, the request indicating that a user terminal of the group is in need for channel resources;
determining if there are resources available for sharing and if so,
controlling a transmission of a response to the request, the response comprising information on available channel resources.

30-34. (canceled)

35. A method, comprising:
controlling a reception of a request from a user terminal of a group of user terminals, the request indicating that the user terminal is in need for channel resources for proximity-based communications within the group of user terminals;
determining if the apparatus has resources available for sharing and, if not,
controlling a transmission of a channel resource request to at least one other user terminal of the group of user terminals.

36-41. (canceled)
